(19) United States
(12) Patent Application Publication
(10) Pub. No.: US 2008/0186640 A1
(43) Pub. Date: Aug. 7, 2008

(54) Magnetoresistance effect type read-head and method of producing the same

(75) Inventors: Masato Matsubara, Kawasaki (JP); Masanori Akie, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/986,468

(22) Filed: Nov. 21, 2007

(30) Foreign Application Priority Data
Feb. 7, 2007 (JP) 2007-027426

(51) Int. Cl. G11B 5/127

(52) U.S. Cl. 360/324.12

(57) ABSTRACT

The magnetoresistance effect type read-head is capable of stably applying bias magnetic fields of hard films to a read-element, stabilizing characteristics of the read-head and improving quality thereof. The magnetoresistance effect type read-head comprises: the read-element; a couple of the hard films sandwiching the read-element, the hard films applying bias magnetic fields to the read-element; and a soft magnetic film being provided on the height direction side, the soft magnetic film connecting an end section of one of the hard films, which is located on the far side with respect to the read-element, to an end section of the other hard film, which is located on the opposite far side with respect to the read-element, so as to circulate magnetic fluxes of the hard films via the soft magnetic film.

### BACKGROUND OF THE INVENTION

The present invention relates to a magnetoresistance type read-head and a method of producing the read-head, more precisely relates to a magnetoresistance type read-head including a CPP (Current Perpendicular to the Plane) type read-element, e.g., TMR element, and a method of producing the read-head.

One of conventional magnetoresistance type read-heads is disclosed in Japanese Patent Gazette No. 11-353621. The conventional read-head is shown in FIG. 8. FIG. 8 shows a read-element 10 and hard films 12a and 12b, which apply bias magnetic fields to the read-element 10, seen from a direction perpendicular to an air bearing surface of the read-head. In the read-head, the read-element 10 including a magnetoresistance effect film is sandwiched between the hard films 12a and 12b, and the three members are included in the same plane.

The magnetoresistance effect film of the read-element 10 comprises a pinned layer, whose magnetization direction is fixed, and a free layer, whose magnetization direction is varied by magnetic fields. The hard films 12a and 12b apply bias magnetic fields to the free layer of the read-element 10 so as to stabilize magnetic domains of the free layer. Note that, the magnetoresistance effect film further comprises an antiferromagnetic layer, which fixes the magnetization direction of the pinned layer by an exchange coupling function, a base layer and a cap layer. Note that, the TMR element has a tunnel barrier layer, which passes a sense current by a tunnel effect.

The hard films 12a and 12b are composed of a magnetic material having a great coercive force, e.g., CoCrPt, CoPt, so as to apply bias magnetic fields to the free layer of the read-element 10. To effectively apply the bias magnetic fields to the free layer, the hard films 12a and 12b are provided very close to the read-element 10. In FIG. 8, the hard films 12a and 12b are provided on the both sides of the read-element 10, and outer end sections of the hard films 12a and 12b, which are located on the far sides with respect to the read-element 10, are bent in the height direction and formed into L-shapes.

In a process of producing the magnetic head, after the read-head and a write-head are formed, the hard films 12a and 12b are magnetized to make magnetization directions parallel to the air bearing surface so as to generate horizontal bias magnetic fields. Since the hard films 12a and 12b are formed into the L-shapes, areas of the films 12a and 12b can be broader than those of mere rectangular films and an entire coercive force of the films 12a and 12b can be greater.

As described above, the hard films 12a and 12b are provided on the both sides of the read-element 10 so as to apply the bias magnetic fields to the free layer of the read-element 10. The conventional hard films 12a and 12b are separately formed on the both sides of the read-element 10. With their shapes, magnetic poles are formed not only at the periphery of the read-element 10 but also at distant places. By forming the distance magnetic poles, the bias magnetic fields are unevenly or unsteadily applied to the read-element 10.

By unevenly or unsteadily applying the bias magnetic fields to the read-element 10, noises of the read-element 10 are generated and output signals of the read-element 10 are widely varied. Therefore, quality of the read-element 10 must be lowered.

### SUMMARY OF THE INVENTION

The present invention was conceived to solve the above described problems.

An object of the present invention is to provide a magnetoresistance effect type read-head, which is capable of stably applying bias magnetic fields of hard films to a read-element, stabilizing characteristics of the read-head and improving quality thereof.

Another object is to provide a method of producing said magnetoresistance effect type read-head.

To achieve the objects, the present invention has following structures.

Namely, the magnetoresistance effect type read-head of the present invention comprises: a read-element; a couple of hard films sandwiching the read-element, the hard films applying bias magnetic fields to the read-element; and a soft magnetic film being provided on the height direction side, the soft magnetic film connecting an end section of one of the hard films, which is located on the far side with respect to the read-element, to an end section of the other hard film, which is located on the opposite far side with respect to the read-element, so as to circulate magnetic fluxes of the hard films via the soft magnetic film.

In the magnetoresistance effect type read-head, the hard films may be arranged along an air bearing surface of the read-head, and the soft magnetic film connecting the hard films may be formed into a loop shape.

In the magnetoresistance effect type read-head, the soft magnetic film may be smoothly connected to the hard films. With this structure, the magnetic fluxes of the hard films can be suitably circulated via the soft magnetic film and a closed magnetic circuit can be formed by the soft magnetic film.

The method of producing a magnetoresistance effect type read-head comprises the steps of: forming a read-element and a couple of hard films, which sandwich the read-element, on a substrate; forming a pattern section connecting an end section of one of the hard films, which is located on the far side with respect to the read-element, to an end section of the other hard film, which is located on the opposite far side with respect to the read-element, on the height direction side, wherein the pattern section is formed by coating a surface of a work with resist and patterning the resist; forming a soft magnetic film on the pattern section; and forming the hard films and the soft magnetic film into a continuous pattern, wherein the continuous pattern is formed by coating surfaces of the hard films and the soft magnetic film with resist having a pattern, which corresponds to the desired hard films and the desired soft magnetic film, and performing ion milling with using the resist as a mask.

In the method, outside dimensions of the hard films may be made greater than those of the desired hard films in the step of forming the hard films, and ends of the pattern section may respectively overlap the hard films, and a width of the pattern section may be made wider than that of the desired soft magnetic film in the step of forming the pattern section. With this method, the hard films and the soft magnetic film can be formed as a correctly continued pattern.

A head slider of the present invention, which is assembled in a magnetic disk apparatus, has a magnetic head, which includes a magnetoresistance effect type read-head and a write-head, and the magnetoresistance effect type read-head comprises: a read-element; a couple of hard films sandwiching the read-element, the hard films applying bias magnetic fields to the read-element; and a soft magnetic film being provided on the height direction side, the soft magnetic film connecting an end section of one of the hard films, which is located on the far side with respect to the read-element, to an end section of the other hard film, which is located on the opposite far side with respect to the read-element, so as to circulate magnetic fluxes of the hard films via the soft magnetic film.

Preferably, in the head slider, the soft magnetic film is smoothly connected to the hard films.

A magnetic disk apparatus of the present invention comprises: a head suspension; a head slider being mounted on the head suspension; and a magnetic head being mounted on the head slider, the magnetic head including a magnetoresistance effect type read-head and a write-head, and the magnetoresistance effect type read-head comprises: a read-element; a couple of hard films sandwiching the read-element, the hard films applying bias magnetic fields to the read-element; and a soft magnetic film being provided on the height direction side, the soft magnetic film connecting an end section of one of the hard films, which is located on the far side with respect to the read-element, to an end section of the other hard film, which is located on the opposite far side with respect to the read-element, so as to circulate magnetic fluxes of the hard films via the soft magnetic film.

In the magnetoresistance effect type read-head of the present invention, the hard films, which sandwich the read-element, are mutually connected by the soft magnetic film, so that the magnetic fluxes of the hard films can be closed by the soft magnetic film or circulated. Therefore, magnetic poles can be formed at periphery of the read-element only, so that the bias magnetic fields of the hard films can be uniformly and stably applied to the read-element, characteristics of the read-element can be stabilized and variation of output signals of the read-head can be restrained. Further, by employing the method of the present invention, said magnetoresistance effect type read-head can be easily produced.

### BRIEF DESCRIPTION OF THE DRAWINGS

Embodiments of the present invention will now be described by way of examples and with reference to the accompanying drawings, in which:

FIG. 1 is an explanation view showing an arrangement of hard films and a soft magnetic film of the read-head of the present invention;

FIG. 2 is a sectional view taken along a line A-A shown in FIG. 1;

FIGS. 3A-3D are explanation views showing steps of producing the read-head of the present invention;

FIGS. 4A-4D are explanation views showing further steps of producing the read-head of the present invention;

FIG. 5 is a sectional view of a magnetic head having the read-head of the present invention;

FIG. 6 is a perspective view of a head slider;

FIG. 7 is a plan view of a magnetic disk apparatus; and

FIG. 8 is an explanation view showing an arrangement of the hard films and the soft magnetic film of the conventional read-head.

### DETAILED DESCRIPTION OF THE EMBODIMENTS

Preferred embodiments of the present invention will now be described in detail with reference to the accompanying drawings.

### (Structure of Read-Head)

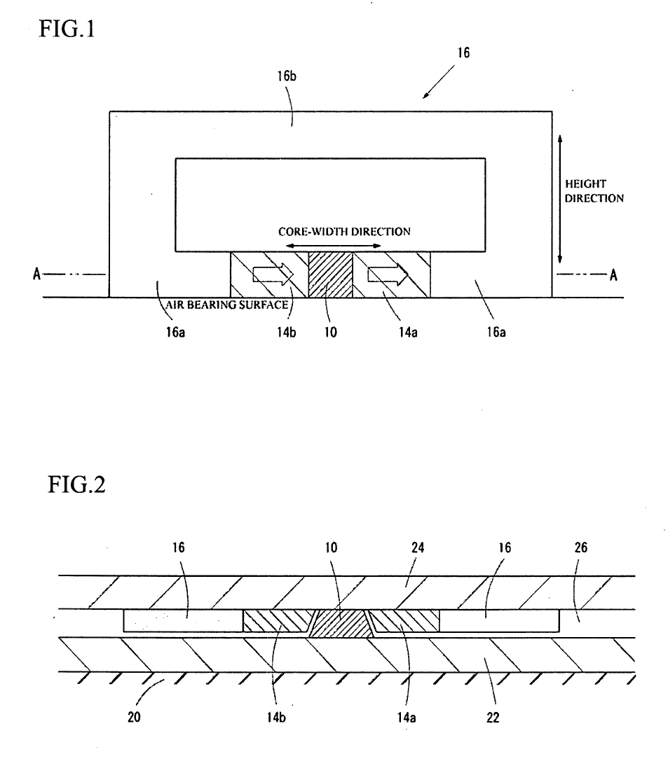

FIG. 1 shows a part of the magnetoresistance effect type read-head of the present invention, which is capable of applying bias magnetic fields to a read-element 10, seen from a direction perpendicular to an air bearing surface.

FIG. 2 is a sectional view taken along a line A-A shown in FIG. 1, which shows a schematic structure of a CPP type read-head. In the read-head, as shown in FIG. 2, a read-element 10 and hard films 14a and 14b, which sandwich the read-element 10, are formed between a lower shielding layer 22, which is formed on a substrate 20, and an upper shielding layer 24.

The read-head of the present embodiment is characterized by: the hard films 14a and 14b sandwiching the read-element 10; and a soft magnetic film 16 being provided on the height direction side (on the opposite side of the air bearing surface) and connecting an outer end section of the hard film 14a, which is located on the far side with respect to the read-element 10, to an outer end section of the hard film 14b, which is located on the opposite far side with respect to the read-element 10. With this structure, the outer end sections of the hard films 14a and 14b are connected by the soft magnetic film 16, and the hard films 14a and 14b are magnetically closed, on the height direction side, by the soft magnetic film 16 so as to circulate magnetic fluxes of said hard films 14a and 14b.

In the present embodiment, the rectangular hard films 14a and 14b are formed to sandwich the read-element 10. Extended sections 16a of the soft magnetic film 16 are respectively extended from the outer ends of the hard films 14a and 14b along the air bearing surface. The soft magnetic film 16 is perpendicularly bent, in the height direction, at outer ends of the extended sections 16a. A connecting section 16b of the soft magnetic film 16 is formed parallel to the air bearing surface and separated therefrom. Namely, the soft magnetic film 16 is formed into a loop shape or a rectangular frame-like shape.

The soft magnetic film 16 continuously connects the outer ends of the hard films 14a and 14b, which are the far side ends with respect to the read-element 10, so as to form a closed magnetic circuit. The shape of the soft magnetic film 16 is not limited to the rectangular frame-like shape. Namely, other shapes, e.g., circular loop, may be optionally employed as far as the magnetic circuit is continuously closed.

In the present embodiment, the outer ends of the hard films 14a and 14b are connected by the loop-shaped soft magnetic film 16. With this structure, magnetic fluxes of the hard films 14a and 14b are circulated via the soft magnetic film 16, magnetic poles are formed in the only parts of the hard films 14a and 14b facing the read-element 10, so that bias magnetic fields can be evenly and stably applied to the read-element 10. By evenly and stably applying the bias magnetic fields to the read-element 10, noises of the read-element 10 can be reduced and variation of output signals thereof can be restrained.

Note that, when the soft magnetic film 16 is formed, connecting sections between the hard films 14a and 14b and the soft magnetic film 16 should be smoothly formed so as to form magnetic poles in the only parts facing the read-element 10. In the present embodiment, as shown in FIGS. 1 and 2, a width and a thickness of the soft magnetic film 16 are made equal to those of the hard films 14a and 14b so as to smoothly connect the soft magnetic film 16 to the hard films 14a and 14b.

The soft magnetic film 16 connects the outer ends of the hard films 14a and 14b so as to form the closed magnetic circuit, so it may be made of a material which is capable of passing magnetic fluxes of the hard films 14a and 14b and which has a magnetic characteristic of small residual magnetization.

In the read-head of the present invention, the hard films 14a and 14b are connected by the soft magnetic film 16. Therefore, the read-head can be suitably applied to the CPP type magnetic head, which detects magnetic signals by passing a sense current in the thickness direction of the read-element 10, as well as a TMR type read-head.

### (Method of Producing Read-Head)

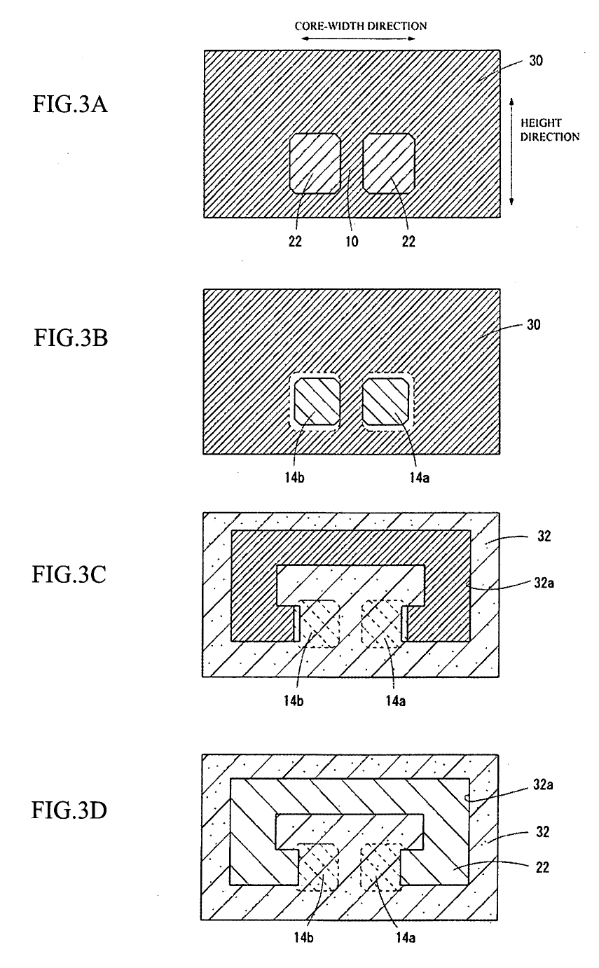

A method of producing the read-head of the present invention will be explained with reference to FIGS. 3A-6.

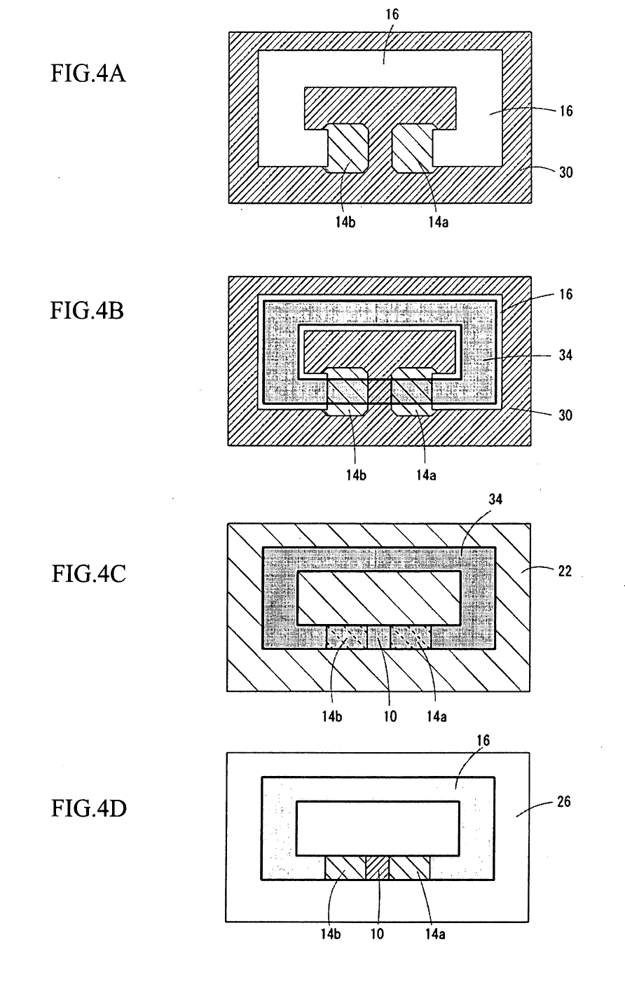

FIGS. 3A-4D show the steps of forming the read-head on a substrate (work), and they are seen from a film forming surface.

In FIG. 3A, a magnetoresistance effect film 30 is formed after the lower shielding layer 22 is formed on the surface of the work, the surface of the magnetoresistance effect film 30 is coated with resist whose pattern corresponds to that of the read-element 10 to be formed, and ion milling is performed.

By performing the ion milling, a width of the read-element 10 in the core-width direction is defined and parts of the lower shielding layer 22 are exposed on the both sides of the read-element 10.

Next, the hard films 14a and 14b are patterned. Namely, the surface of the work is coated with resist, and then the resist is patterned so as to expose parts of the work, in which the hard films 14a and 14b will be formed.

In FIG. 3B, an insulating layer is formed on the surface of the work, the hard films 14a and 14b are formed by sputtering, and then the resist is removed.

In FIG. 3C, the surface of the work is coated with resist 32 so as to pattern the soft magnetic film 16, and a part 32a of the resist 32, which corresponds to the soft magnetic film 16 to be formed, is removed by a patterning process. The part 32a, in which the soft magnetic film 16 will be formed, is formed to partially overlap the hard films 14a and 14b and formed into the loop shape on the height direction side.

In FIG. 3D, ion milling is performed with using the resist 32 as a mask. A part of the magnetoresistance effect film 30 and parts of the hard films 14a and 14b are removed from the inside area of the part 32a.

In FIG. 4A, an insulating film is formed so as to insulate the soft magnetic film 16 from the lower shielding layer 22, and then the soft magnetic film 16 is formed. After forming the insulating film, a plating seed layer is formed on the surface of the work, and a soft magnetic film whose thickness is equal to that of the hard films 14a and 14b is formed by plating. In the state shown in FIG. 4A, the resist 32 is removed or lifted off after completing the plating process, and the soft magnetic film 16 is connected to the hard films 14a and 14b. The ion milling is performed with using the parts 32a as a mask, and the soft magnetic film 16 is formed in the part 32a. Therefore, the soft magnetic film 16 is correctly positioned with respect to the hard films 14a and 14b and connected to the hard films 14a and 14b.

In FIGS. 4B and 4C, the hard films 14a and 14b and the soft magnetic film 16 are finally patterned.

In FIG. 4B, resist 34 is patterned to correspond to the desired patterns of the hard films 14a and 14b and the soft magnetic film 16. The resist 34 is patterned so as to coat the parts which will be left as the hard films 14a and 14b and the soft magnetic film 16. In the patterning process, widths of the hard films 14a and 14b and the soft magnetic film 16 are previously made wider than those of final patterns, and outer edges of the resist 34 are slightly located on the inner side of outer edges of the hard films 14a and 14b and the soft magnetic film 16.

In FIG. 4C, ion milling is performed with using the resist 34 as a mask, so that the magnetoresistance effect film 30, etc., other than the resist 34 corresponding to the hard films 14a and 14b and the soft magnetic film 16, are removed.

In FIG. 4D, an insulating film 26 is formed on the surface of the work, and the resist 34 is lifted off. The insulating film 26 does not coat the parts coated with the resist 34. Therefore, the read-element 10, the hard films 14a and 14b and the soft magnetic film 16 are exposed.

Next, the upper shielding layer 24 is formed to coat the hard films 14a and 14b and the soft magnetic film 16. By forming the upper shielding layer 24, the read-head is completed.

In the production method of the present embodiment, as shown in FIG. 4C, the hard films 14a and 14b and the soft magnetic film 16 are patterned in the same step after forming them. The hard films 14a and 14b and the soft magnetic film 16, which have the same width, can be perfectly connected, so that the soft magnetic film 16 can be smoothly connected to the hard films 14a and 14b.

### (Magnetic Head)

A magnetic head having the read-head of the present invention is produced by: firstly forming the above described read-head; secondly forming a write-head; and then magnetizing the hard films 14a and 14b. In the magnetizing step, a strong magnetic field is applied so as to make the magnetization directions of the hard films 14a and 14b parallel to the air bearing surface. Arrows shown in FIG. 1 indicate the magnetization directions of the hard films 14a and 14b, which are parallel to the air bearing surface. Since the hard films 14a and 14b are made of a magnetic material having a great coercive force, the magnetized hard films 14a and 14b always apply bias magnetic fields to the read-element 10.

FIG. 5 shows an example of the magnetic head having the above described read-head. The magnetic head 70 comprises a read-head 50 and a write-head 60. The read-head 50 includes the above described lower shielding layer 22, the read-element 10 and the upper shielding layer 24. The read-head 50 of the present embodiment is characterized by the loop-shaped soft magnetic film 16, which is connected to the hard films 14a and 14b.

The write-head 60 includes a lower magnetic pole 62, an upper magnetic pole 63, a write-gap 61 sandwiched between the magnetic poles 62 and 63, and a coil 64 for writing data.

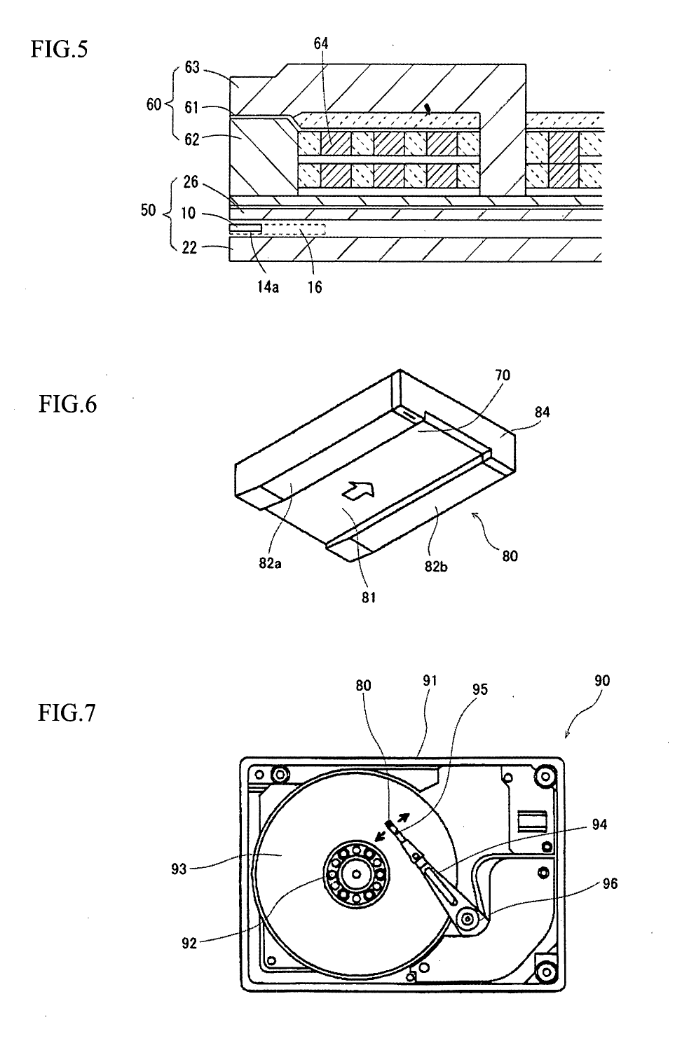

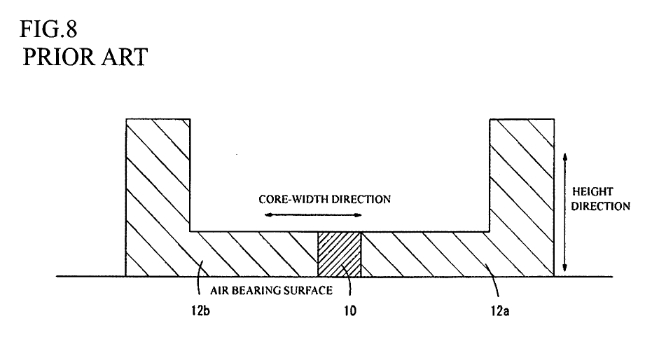

FIG. 6 shows a head slider, on which the above described magnetic head 70 is mounted. In the head slider 80, floating rails 82a and 82b are formed on an air bearing surface of a main body section 81, which faces a recording medium, and the magnetic head 70 is provided to a front end of the head slider 80, which is located on the downstream side of an air stream, so as to face the recording medium. The magnetic head 70 is coated and protected with a protection film 84 composed of, for example, alumina.

FIG. 7 shows an example of a magnetic disk apparatus having the sliders 80. The magnetic disk apparatus 90 comprises a casing 91, in which a plurality of magnetic disks 93 are rotated by a spindle motor 92. A carriage arm 94, which can be swung parallel to the surface of the magnetic disk 93, is provided adjacent to each of the magnetic disks 93. A head suspension 95 is attached to a front end the carriage arm 94, and the head slider 80 is attached to a front end of the head suspension 95. The head slider is attached on a surface of the head suspension 95 facing the surface of the magnetic disk 93.

When the magnetic disks 93 are rotated by the spindle motor 92, each of the head sliders 80 is floated from the surface of each of the magnetic disks 93 by an air stream generated by the rotation thereof. When data are written or read by the magnetic head 70 attached to each of the head sliders 80, each of the carriage arms 94 is swung, by an actuator 96, for a seeking action.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A magnetoresistance effect type read-head, comprising:
a read-element;
a couple of hard films sandwiching said read-element, said hard films applying bias magnetic fields to said read-element; and
a soft magnetic film being provided on the height direction side, said soft magnetic film connecting an end section of one of said hard films, which is located on the far side with respect to said read-element, to an end section of the other hard film, which is located on the opposite far side with respect to said read-element, so as to circulate magnetic fluxes of said hard films via said soft magnetic film.

2. The magnetoresistance effect type read-head according to claim 1,
wherein said hard films are arranged along an air bearing surface of said read-head, and
said soft magnetic film connecting said hard films is formed into a loop shape.

3. The magnetoresistance effect type read-head according to claim 1,
wherein said soft magnetic film is smoothly connected to said hard films.

4. A method of producing a magnetoresistance effect type read-head, comprising the steps of:
forming a read-element and a couple of hard films, which sandwich said read-element, on a substrate;
forming a pattern section connecting an end section of one of said hard films, which is located on the far side with respect to said read-element, to an end section of the other hard film, which is located on the opposite far side with respect to said read-element, on the height direction side, wherein said pattern section is formed by coating a surface of a work with resist and patterning the resist;
forming a soft magnetic film on the pattern section; and
forming said hard films and said soft magnetic film into a continuous pattern, wherein the continuous pattern is formed by coating surfaces of said hard films and said soft magnetic film with resist having a pattern, which corresponds to the desired hard films and the desired soft magnetic film, and performing ion milling with using the resist as a mask.

5. The method according to claim 4,
wherein outside dimensions of said hard films are made greater than those of the desired hard films in said step of forming said hard films, and
ends of said pattern section respectively overlap said hard films, and a width of said pattern section is made wider than that of the desired soft magnetic film in said step of forming said pattern section.

6. A head slider of a magnetic disk apparatus having a magnetic head, which includes a magnetoresistance effect type read-head and a write-head,
wherein said magnetoresistance effect type read-head comprises:
a read-element;
a couple of hard films sandwiching said read-element, said hard films applying bias magnetic fields to said read-element; and
a soft magnetic film being provided on the height direction side, said soft magnetic film connecting an end section of one of said hard films, which is located on the far side with respect to said read-element, to an end section of the other hard film, which is located on the opposite far side with respect to said read-element, so as to circulate magnetic fluxes of said hard films via said soft magnetic film.

7. The head slider according to claim 6,
wherein said soft magnetic film is smoothly connected to said hard films.

8. A magnetic disk apparatus, comprising:
a head suspension;
a head slider being mounted on said head suspension; and
a magnetic head being mounted on said head slider, said magnetic head including a magnetoresistance effect type read-head and a write-head,
wherein said magnetoresistance effect type read-head comprises:
a read-element;
a couple of hard films sandwiching said read-element, said hard films applying bias magnetic fields to said read-element; and
a soft magnetic film being provided on the height direction side, said soft magnetic film connecting an end section of one of said hard films, which is located on the far side with respect to said read-element, to an end section of the other hard film, which is located on the opposite far side with respect to said read-element, so as to circulate magnetic fluxes of said hard films via said soft magnetic film.
